(19) United States
(12) Patent Application Publication
(10) Pub. No.: US 2014/0189218 A1
(43) Pub. Date: Jul. 3, 2014

(54) METHOD OF PROGRAMMING DATA INTO NONVOLATILE MEMORY AND METHOD OF READING DATA FROM NONVOLATILE MEMORY

(71) Applicant: Samsung Electronics Co., Ltd., Suwon-Si (KR)

(72) Inventors: Kyounglae CHO, Yongin-si (KR); Kui-Yon MOON, Hwaseong-si (KR); Younggyu KANG, Yongin-si (KR); Jaephil KONG, Seoul (KR)

(73) Assignee: SAMSUNG ELECTRONICS CO., LTD., Suwon-Si (KR)

(21) Appl. No.: 14/138,221

(22) Filed: Dec. 23, 2013

(30) Foreign Application Priority Data
Jan. 2, 2013 (KR) 10-2013-0000280

(51) Int. Cl. G06F 12/02

(52) U.S. Cl. CPC G06F 12/0246
USPC 711/103

(57) ABSTRACT

Disclosed is a method of programming data into a nonvolatile memory that includes a plurality of memory cells connected with a word line, each memory cell storing first to mth bits of a plurality of bits, the plurality of bits forming first to mth pages. The method includes generating first to mth metadata based on first to mth page data received; rearranging the first to mth metadata to generate first to mth rearranged metadata; and programming the first to mth rearranged metadata and the first to mth page data into the first to mth pages, respectively.

### CROSS-REFERENCE TO RELATED APPLICATIONS

A claim for priority under 35 U.S.C. §119 is made to Korean Patent Application No. 10-2013-0000280 filed Jan. 2, 2013, in the Korean Intellectual Property Office, the entire contents of which are hereby incorporated by reference.

### BACKGROUND

Some example embodiments of inventive concepts described herein relate to a semiconductor memory, and more particularly, relate to a program method capable of programming data into a nonvolatile memory and/or a read method capable of reading data from the nonvolatile memory.

A semiconductor memory device is a memory device fabricated using semiconductors such as silicon (Si), germanium (Ge), gallium arsenide (GaAs), indium phosphide (InP), and the like. Semiconductor memory devices are classified into volatile memory devices and nonvolatile memory devices.

The volatile memory devices may lose stored contents at power-off. The volatile memory devices include a static RAM (SRAM), a dynamic RAM (DRAM), a synchronous DRAM (SDRAM), and the like. The nonvolatile memory devices may retain stored contents even at power-off. The nonvolatile memory devices include a read only memory (ROM), a programmable ROM (PROM), an electrically programmable ROM (EPROM), an electrically erasable and programmable ROM (EEPROM), a flash memory device, a phase-change RAM (PRAM), a magnetic RAM (MRAM), a resistive RAM (RRAM), a ferroelectric RAM (FRAM), and the like.

A semiconductor memory may store user data generated by a user. The semiconductor memory may further store metadata. The metadata may be data needed to manage the semiconductor memory. The metadata may be generated by the semiconductor memory. Alternatively, a controller of controlling the semiconductor memory may generate the metadata, and the metadata may be stored at the semiconductor memory. Since the metadata is data necessary to manage the semiconductor memory, a management policy may be required for providing higher reliability compared with user data.

### SUMMARY

Some example embodiments of inventive concepts provide a method of programming data into a nonvolatile memory that includes a plurality of memory cells connected with a word line, each memory cell storing first to mth bits of a plurality of bits, the plurality of bits forming first to mth pages, including first to mth page data, the method comprising generating first to mth metadata based on the first to mth page data; rearranging the first to mth metadata to generate first to mth rearranged metadata; and programming the first to mth rearranged metadata and the first to mth page data into the first to mth pages, respectively.

In some example embodiments, the first to mth rearranged metadata are equal to one another.

In some example embodiments, the rearranging includes sequentially merging the first to mth metadata to generate merged metadata; and selecting the merged metadata in common as the first to mth rearranged metadata.

In some example embodiments, the rearranging includes sequentially merging the first to mth metadata to generate merged metadata; reversing the merged metadata to generate reversed metadata; selecting the merged metadata in common as a first group of metadata of the first to mth rearranged metadata; and selecting the reversed metadata in common as a second group of metadata of the first to mth rearranged metadata.

In some example embodiments, the generating includes generating first to (m−1)th metadata based on first to (m−1)th page data received; programming the first to (m−1)th page data and the first to (m−1)th metadata into a buffer area; receiving the mth page data; generating the mth metadata based on the mth page data; and reading the first to (m−1)th page data and the first to (m−1)th metadata from the buffer area.

In some example embodiments, the nonvolatile memory includes a single-level cell area configured to store a bit per memory cell, the buffer area being the single-level cell area.

In some example embodiments, the first to (m−1)th page data and the first to (m−1)th metadata are programmed into memory cells connected with first to (m−1)th word lines of the single-level cell area, respectively.

In some example embodiments, the first to mth metadata and the first to mth rearranged metadata are generated by a controller configured to control the nonvolatile memory.

In some example embodiments, in the programming the first to mth rearranged metadata and the first to mth page data into the first to mth pages, the controller transfers the first to mth rearranged metadata and the first to mth page data to the nonvolatile memory.

In some example embodiments, in the generating first to mth metadata based on first to mth page data received, a controller configured to control the nonvolatile memory generates the first to mth metadata and the controller transfers the first to mth rearranged metadata and the first to mth page data to the nonvolatile memory.

In some example embodiments, the rearranging is performed by the nonvolatile memory.

Some example embodiments of inventive concepts are directed to provide a method of reading data from a nonvolatile memory that includes a plurality of memory cells connected with a word line, each memory cell storing first to mth bits of a plurality of bits, the plurality of bits forming first to mth pages, including first to mth page data, the method including reading page data and metadata, corresponding to the page data, from a page selected from the first to mth pages of the nonvolatile memory; and selecting a part of the read metadata as target metadata of the read page data.

In some example embodiments, the selecting includes selecting a part of the read metadata as target metadata of the read page data based on an address of the read page data.

In some example embodiments, the method includes performing error correction on the read page data using the target metadata.

In some example embodiments, the method includes outputting the read page data and target metadata to an external device.

Some example embodiments of inventive concepts are directed to provide a method of programming data into a nonvolatile memory, the method including generating one or more first metadata corresponding to one or more received page data; rearranging the one or more first metadata to generate one or more rearranged metadata; transferring the one or more rearranged metadata and the one or more received page data into a word line of the nonvolatile memory, the word line storing one or more pages of data in a plurality of memory cells, each memory cell storing one or more bits of the one or more pages of data.

The rearranging may include sequentially merging the one or more first metadata to generate merged metadata; and selecting the merged metadata in common as the one or more rearranged metadata.

The rearranging may include sequentially merging the one or more first metadata to generate merged metadata; reversing the merged metadata to generate reversed metadata; selecting the merged metadata in common as a first group of metadata of the one or more rearranged metadata; and selecting the reversed metadata in common as a second group of metadata of the one or more rearranged metadata.

The generating may include generating first to (m−1)th metadata based on first to (m−1)th page data received; programming the first to (m−1)th page data and the first to (m−1)th metadata into a buffer area; receiving the mth page data; generating the mth metadata based on the mth page data; and reading the first to (m−1)th page data and the first to (m−1)th metadata from the buffer area.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a memory system according to an example embodiment of inventive concepts;

FIG. 2 is a block diagram schematically illustrating a nonvolatile memory according to an example embodiment of inventive concepts;

FIG. 3 is a flow chart schematically illustrating a program method according to an example embodiment of inventive concepts;

FIG. 4 is a flow chart schematically illustrating a metadata rearranging method according to an example embodiment of inventive concepts;

FIG. 5 is a diagram schematically illustrating an example embodiment in which rearranged metadata is generated based on page data;

FIG. 6 is a diagram schematically illustrating an example where metadata and page data generated according to a conventional manner is programmed;

FIG. 7 is a diagram schematically illustrating an example embodiment where metadata and page data generated according to an example embodiment of inventive concepts is programmed;

FIG. 8 is a flow chart schematically illustrating a metadata rearranging method according to another example embodiment of inventive concepts;

FIG. 9 is a diagram schematically illustrating another example embodiment where rearranged metadata is generated based on page data;

FIG. 10 is a diagram schematically illustrating another example embodiment where metadata and page data generated according to an example embodiment of inventive concepts is programmed;

FIG. 11 is a block diagram schematically illustrating a nonvolatile memory according to another example embodiment of inventive concepts;

FIG. 12 is a flow chart schematically illustrating a program method according to another example embodiment of inventive concepts;

FIG. 13 is a flow chart schematically illustrating an example embodiment where data is read from a nonvolatile memory;

FIG. 14 is a block diagram schematically illustrating a memory system according to another example embodiment of inventive concepts;

FIG. 15 is a flow chart schematically illustrating a program method according to another example embodiment of inventive concepts to program data into a nonvolatile memory;

FIG. 16 is a flow chart schematically illustrating a read method according to another example embodiment of inventive concepts to read data from a nonvolatile memory;

FIG. 17 is a block diagram schematically illustrating an application of a memory system according to an example embodiment of inventive concepts;

FIG. 18 is a block diagram schematically illustrating a memory card according to an example embodiment of inventive concepts;

FIG. 19 is a block diagram schematically illustrating a solid state drive according to an example embodiment of inventive concepts; and

FIG. 20 is a block diagram schematically illustrating a computing system according to an example embodiment of inventive concepts.

### DETAILED DESCRIPTION

Example embodiments will be described in detail with reference to the accompanying drawings. Example embodiment of inventive concepts, however, may be embodied in various different forms, and should not be construed as being limited only to the illustrated example embodiments. Rather, these example embodiments are provided as examples so that this disclosure will be thorough and complete, and will fully convey the concept of example embodiments of inventive concepts to those skilled in the art. Accordingly, known processes, elements, and techniques are not described with respect to some example embodiments of inventive concepts. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of example embodiments of inventive concepts.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular example embodiments only and is not intended to be limiting of example embodiments of inventive concepts. As used herein, the singular forms “a”, “an” and “the” are intended to include the plural forms as well, unless the context clearly indicates otherwise. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which example embodiments of inventive concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

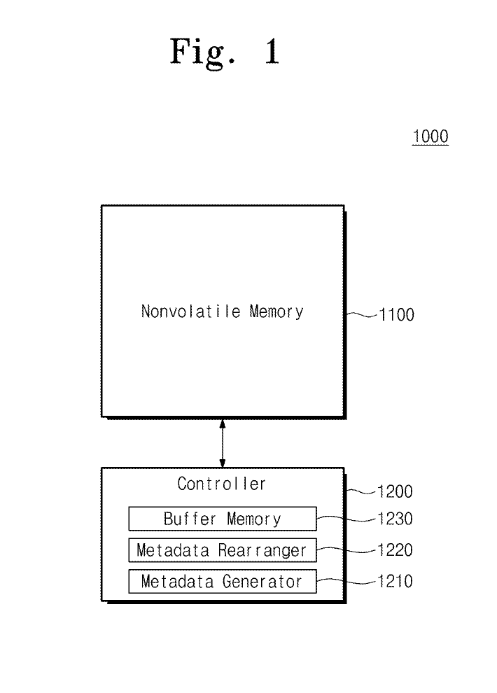

FIG. 1 is a block diagram schematically illustrating a memory system 1000 according to an example embodiment of inventive concepts. Referring to FIG. 1, a memory system 1000 may include a nonvolatile memory 1100 and a controller 1200.

The nonvolatile memory 1100 may store data according to a control of the controller 1200. The nonvolatile memory 1100 may include a flash memory, an MRAM, a PRAM, an RRAM, an FRAM, and so on. For a simple description, example embodiments of inventive concepts will be described under the assumption that the nonvolatile memory 1100 is the flash memory. However, example embodiments of inventive concepts may vary and are not limited thereto.

The controller 1200 may be configured to control the nonvolatile memory device 1100. For example, the controller 1200 may be configured to control a read operation, a write operation, an erase operation, a read operation, and a background operation of the nonvolatile memory device 1100. The controller 1200 may be configured to provide an interface between the nonvolatile memory device 1100 and a host. The controller 1200 may be configured to drive firmware for controlling the nonvolatile memory device 1100.

The controller 1200 may include a metadata generator 1210, a metadata rearranger 1220, and a buffer memory 1230. The metadata generator 1210 may be configured to generate metadata based on data received from an external device (e.g., host). For example, the metadata generator 1210 may generate data needed to manage the nonvolatile memory 1100 or data stored at the nonvolatile memory 1100 such as parity for error checking and correction, addresses (e.g., logical addresses), and so on.

The metadata rearranger 1220 may rearrange metadata generated by the metadata generator 1210.

The buffer memory 1230 may temporarily store data generated or changed in the controller 1200. The buffer memory 1230 may temporarily store data provided to the controller 1200 or output from the controller 1200.

The metadata generator 1210 or the metadata rearranger 1220 may be implemented by software driven at the controller 1200, hardware provided in the controller 1200, or a combination of hardware and software.

The controller 1200 may communicate with an external host. For example, the controller 1200 may be configured to communicate with an external host through at least one of various protocols such as an USB (Universal Serial Bus) protocol, an MMC (multimedia card) protocol, a PCI (peripheral component interconnection) protocol, a PCI-E (PCI-express) protocol, an ATA (Advanced Technology Attachment) protocol, a Serial-ATA protocol, a Parallel-ATA protocol, a SCSI (small computer small interface) protocol, an ESDI (enhanced small disk interface) protocol, an IDE (Integrated Drive Electronics) protocol, and so on.

The controller 1200 and the nonvolatile memory device 1100 may be integrated in one semiconductor device. For example, the controller 1200 and the nonvolatile memory device 1100 may be integrated in one semiconductor device to constitute a solid state drive (SSD). The controller 1200 and the nonvolatile memory device 1100 may be integrated in one semiconductor device to form a memory card. For example, the controller 1200 and the nonvolatile memory device 1100 may be integrated in one semiconductor device to form a memory card such as a PC (or, PCMCIA) card, a Compact Flash (CF) card, a SmartMedia (SM) card, a memory stick, a multimedia card (MMC, RS-MMC, MMCmicro), an SD card (SD, miniSD, SDHC), a Universal Flash Storage (UFS) device, or the like.

In some example embodiments, the memory system 1000 may be used as computer, portable computer, Ultra Mobile PC (UMPC), workstation, net-book, PDA, web tablet, wireless phone, mobile phone, smart phone, e-book, PMP (portable multimedia player), digital camera, digital audio recorder/player, digital picture/video recorder/player, portable game machine, navigation system, black box, 3-dimensional television, a device capable of transmitting and receiving information at a wireless circumstance, one of various electronic devices constituting a home network, one of various electronic devices constituting a computer network, one of various electronic devices constituting a telematics network, RFID, or one of various electronic devices constituting a computing system.

In some example embodiments, the nonvolatile memory 1100 or the memory system 1000 may have various types of packages such as PoP (Package on Package), Ball grid arrays (BGAs), Chip scale packages (CSPs), Plastic Leaded Chip Carrier (PLCC), Plastic Dual In-Line Package (PDI2P), Die in Waffle Pack, Die in Wafer Form, Chip On Board (COB), Ceramic Dual In-Line Package (CERDIP), Plastic Metric Quad Flat Pack (MQFP), Thin Quad Flatpack (TQFP), Small Outline (SOIC), Shrink Small Outline Package (SSOP), Thin Small Outline (TSOP), System In Package (SIP), Multi Chip Package (MCP), Wafer-level Fabricated Package (WFP), Wafer-Level Processed Stack Package (WSP), and the like.

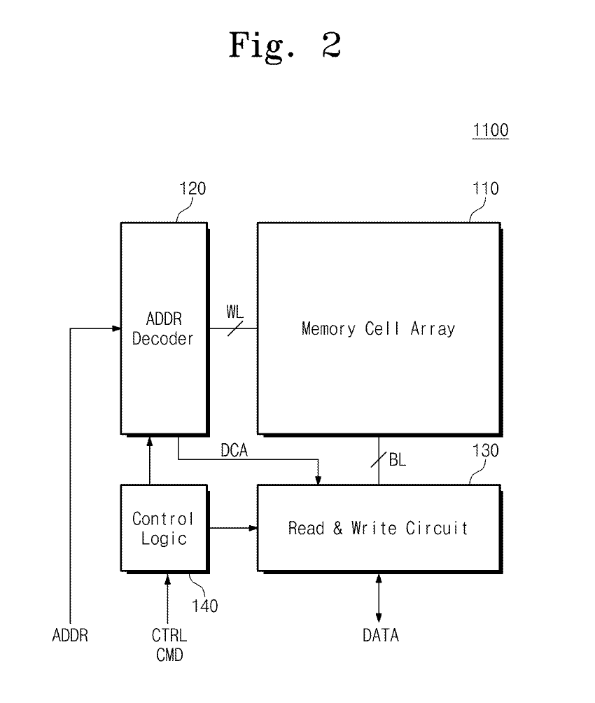

FIG. 2 is a block diagram schematically illustrating a nonvolatile memory 1100 according to an example embodiment of inventive concepts. Referring to FIGS. 1 and 2, a nonvolatile memory 1100 may include a memory cell array 110, an address decoder 120, a read/write circuit 130, and control logic 140.

The memory cell array 110 may be connected to the address decoder 120 via word lines and to the read/write circuit 130 via bit lines. The memory cell array 110 may include a plurality of memory cells. In some example embodiments, memory cells arranged in a row direction may be connected to word lines WL, and memory cells arranged in a column direction may be connected to bit lines BL. For example, memory cells arranged in a column direction may form a plurality of cell groups (e.g., strings) that are connected to the bit lines.

In some example embodiments, the memory cell array 110 may include multiple memory cells each storing first to mth bits. Nth bits (N being 1 to m) of memory cells connected with a word line may form an Nth page.

The address decoder 120 may be connected to the memory cell array 110 via the word lines WL. The address decoder 120 may operate responsive to the control of the control logic 140. The address decoder 120 may receive an address ADDR from an external device (e.g., controller 1100).

The address decoder 120 may decode a row address of the input address ADDR, and may select the word lines WL in response to the decoded row address. The address decoder 120 may decode a column address of the input address ADDR to transfer it to the read/write circuit 130. In some example embodiments, the address decoder 120 may include constituent elements such as a row decoder, a column decoder, an address buffer, and so on.

The read/write circuit 130 may be coupled with the memory cell array 110 via bit lines BL. The read/write circuit 130 may operate responsive to the control of the control logic 140. The read/write circuit 130 may select bit lines BL in response to the decoded column address DCA provided from the address decoder 120.

The read/write circuit 130 may exchange data with the external device (e.g., controller 1200). The read/write circuit 130 may receive data from the external device to program the memory cell array 110. The read/write circuit 130 may read data from the memory cell array 110 to transfer to the external device. The read/write circuit 130 may read data from a first storage region of the memory cell array 110 to write at a second storage region of the memory cell array 110. For example, the read/write circuit 130 may be configured to perform a copy-back operation.

In some example embodiments, the read/write circuit 130 may include constituent elements such as a page buffer (or, a page register), a column selecting circuit, a data buffer, and the like. In other example embodiments, the read/write circuit 130 may include constituent elements such as a sense amplifier, a write driver, a column selecting circuit, a data buffer, and the like.

The control logic 140 may be connected to the address decoder 120 and the read/write circuit 130. The control logic 140 may be configured to control an overall operation of the nonvolatile memory 1100. The control logic 140 may operate responsive to control signals CTRL and commands CMD transferred from the external device.

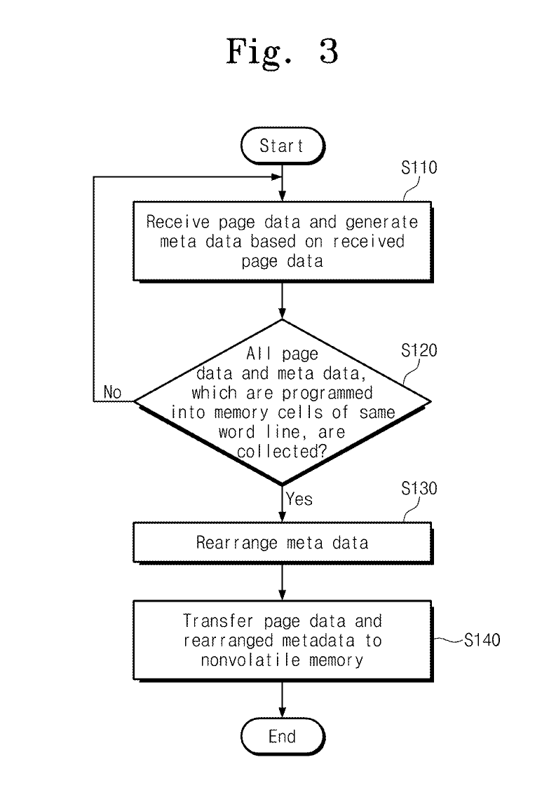

FIG. 3 is a flow chart schematically illustrating a program method according to an example embodiment of inventive concepts. Referring to FIGS. 1 and 3, in operation S110, page data may be received and metadata may be generated based on the input page data. For example, when page data is provided to a controller 1200, a metadata generator 1210 may generate metadata based on the input page data.

In operation S120, whether all page data and metadata to be programmed into memory cells in a word line are collected may be determined. If all page data and metadata are determined to be collected, the method may proceed to operation S130. If all page data and metadata are determined not to be collected, the method may proceed back to operation S110.

For example, operations S110 and S120 may be iterated until all page data to be programmed into memory cells in a word line is received and all metadata associated with the received page data is generated. Page data and metadata may be stored in a buffer memory 1230 during iterations of the operations S110 and S120. When each memory cell stores first to mth bits, memory cells connected with a word line may form first to mth pages. The controller 1200 may iterate the operations S110 and S120 until first to mth page data to be programmed into memory cells in a word line and first to mth metadata associated with the first to mth page data are accumulated at the buffer memory 1230.

In operation S130, metadata may be rearranged. A metadata rearranger 1220 of the controller 1200 may rearrange the first to mth metadata accumulated at the buffer memory 1230 to generate first to mth rearranged metadata.

In operation S140, the controller 1200 may send the page data and the rearranged metadata to a nonvolatile memory 1100. The controller 1200 may provide the nonvolatile memory 1100 with the first to mth page data and the first to mth rearranged metadata corresponding to the first to mth page data.

The nonvolatile memory 1100 may program the first to mth page data and the first to mth rearranged metadata into memory cells connected to a word line. For example, the nonvolatile memory 1100 may program the first to mth page data and the first to mth rearranged metadata into memory cells connected to a word line at the same time.

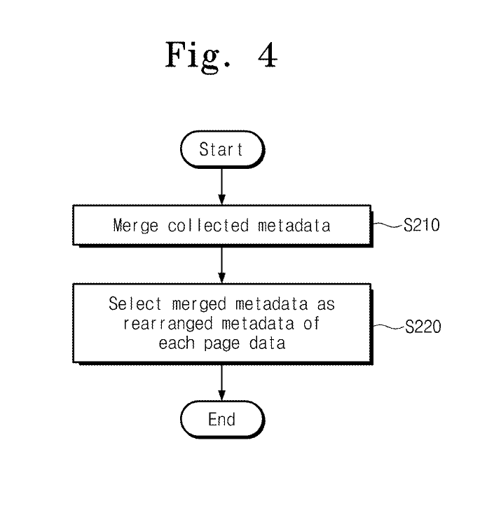

FIG. 4 is a flow chart schematically illustrating a metadata rearranging method according to an example embodiment of inventive concepts. Referring to FIGS. 1 and 4, in operation S210, a metadata rearranger 1220 may merge first to mth metadata stored at a buffer memory 1230.

In operation S220, the metadata rearranger 1220 may select the merged metadata as rearranged metadata of each page of data.

In some example embodiments, the metadata rearranger 1220 may sequentially merge the first to mth metadata to generate one rearranged metadata. The metadata rearranger 1220 may select the rearranged metadata as first to mth rearranged metadata respectively corresponding to first to mth page data. For example, metadata having the same data may be selected as metadata of the first to mth page data.

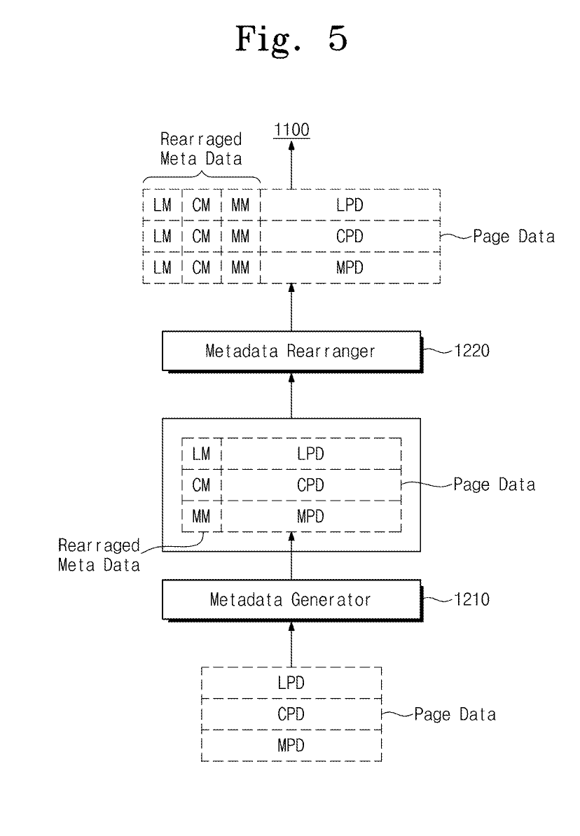

FIG. 5 is a diagram schematically illustrating an example embodiment in which rearranged metadata is generated based on page data. Referring to FIGS. 1, 4 and 5, first to mth page data may be received from an external device of a controller 1200. The first to mth page data may be received simultaneously or sequentially. For example, the first to mth page data may include LSB page data LPD, CSB page data CPD, and MSB page data MPD. However, example embodiment of inventive concepts may vary and are not limited thereto.

A metadata generator 1210 may generate metadata based on LSB page data LPD, CSB page data CPD, and MSB page data MPD. The metadata generator 1210 may generate LSB metadata LM based on the LSB page data LPD, CSB metadata CM based on the CSB page data CPD, and MSB metadata MM based on the MSB page data MPD.

The metadata rearranger 1220 may perform metadata rearrangement. The metadata rearranger 1220 may merge the LSB metadata LM, the CSB metadata CM, and the MSB metadata MM to generate one rearranged metadata. The metadata rearranger 1220 may select the rearranged metadata as common metadata of the LSB page data LPD, the CSB page data CPD, and the MSB page data MPD. Thus, metadata respectively corresponding to the LSB page data LPD, the CSB page data CPD, and the MSB page data MPD may be equal to one another.

In some example embodiments, a part or all of data provided to the metadata generator 1210, data processed by the metadata generator 1210 or data output from the metadata generator 1210 may pass through the buffer memory 1230. A part or all of data provided to the metadata rearranger 1220, data processed by the metadata rearranger 1220 or data output from the metadata rearranger 1220 can pass through the buffer memory 1230.

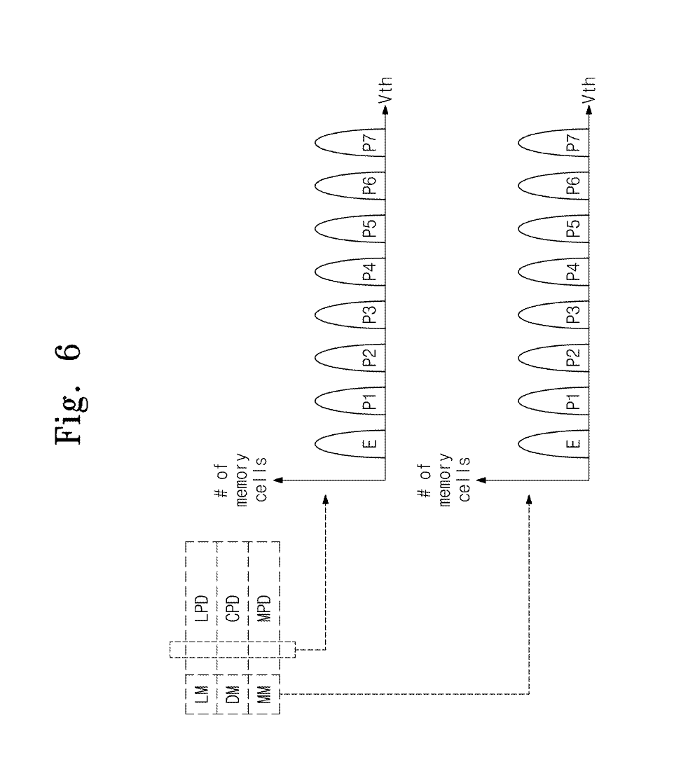

FIG. 6 is a diagram schematically illustrating an example where metadata and page data generated according to a conventional manner is programmed. For example, a program operation will be described based on a flash memory where data is stored using threshold voltages of memory cells.

Referring to FIG. 6, LSB page data LPD may be programmed into a first page of memory cells connected with the same word line together with LSB metadata LM. CSB page data CPD may be programmed into a second page of memory cells connected with the same word line together with CSB metadata CM. MSB page data MPD may be programmed into a third page of memory cells connected with the same word line together with MSB metadata MM.

A memory cell (first memory cell) connected with the same word line programmed with user data may store one bit of the LSB page data LPD, one bit of the CSB page data CPD, and one bit of the MSB page data MPD. Since values of respective bits of the LSB page data LPD, the CSB page data CPD, and the MSB page data MPD are arbitrary, the first memory cell may have one of eight logic values. Thus, a threshold voltage of the first memory cell may correspond to one of eight logic states E and P1 to P7.

A memory cell (second memory cell) connected with the same word line programmed with metadata may store one bit of the LSB metadata LM, one bit of the CSB metadata CM, and one bit of the MSB metadata MM. Since values of respective bits of the LSB metadata LM, the CSB metadata CM, and the MSB metadata MM are arbitrary, the second memory cell may have one of eight logic values. Thus, a threshold voltage of the second memory cell may correspond to one of eight logic states E and P1 to P7.

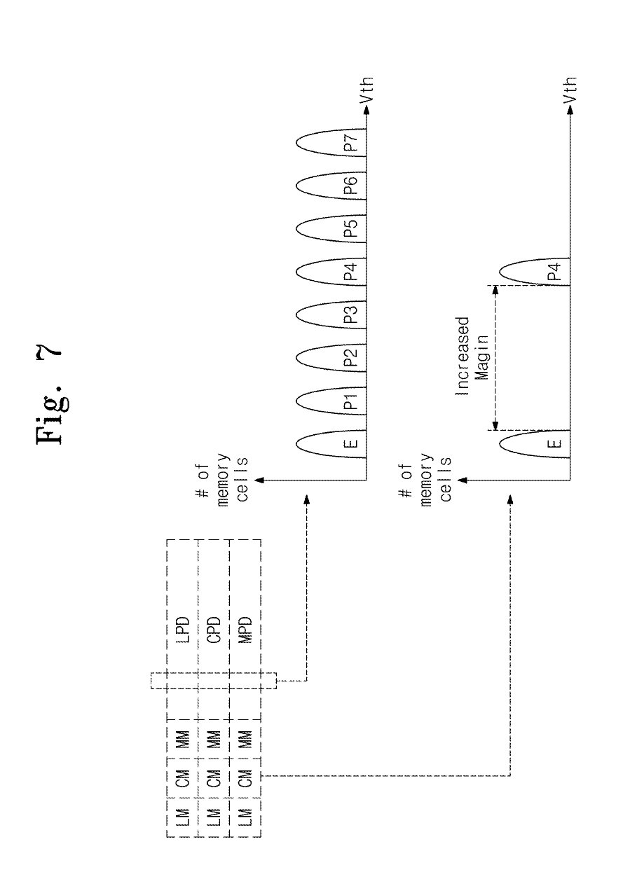

FIG. 7 is a diagram schematically illustrating an example embodiment where metadata and page data generated according to an example embodiment of inventive concepts is programmed. For example, a program operation will be described based on a flash memory where data is stored using threshold voltages of memory cells.

Referring to FIG. 7, LSB page data LPD may be programmed into a first page of memory cells connected with the same word line together with rearranged metadata LM, CM, and MM. CSB page data CPD may be programmed into a second page of memory cells connected with the same word line together with rearranged metadata LM, CM, and MM. MSB page data MPD may be programmed into a third page of memory cells connected with the same word line together with rearranged metadata LM, CM, and MM.

A memory cell (first memory cell) connected with the same word line programmed with user data may store one bit of the LSB page data LPD, one bit of the CSB page data CPD, and one bit of the MSB page data MPD. Since values of respective bits of the LSB page data LPD, the CSB page data CPD, and the MSB page data MPD are arbitrary, the first memory cell may have one of eight logic values. Thus, a threshold voltage of the first memory cell may correspond to one of eight logic states E and P1 to P7.

A memory cell (second memory cell) connected with the same word line programmed with rearranged metadata may store bits such that a bit of the rearranged metadata LM, CM, and MM is iteratively arranged.

For example, in a first page at which the LSB page data LPD is stored, a value of a bit, placed at a particular location, of the rearranged metadata LM, CM, and MM may be ‘1’ or ‘0’.

In a second page at which the CSB page data CPD is stored, a value of a bit, placed at a particular location, of the rearranged metadata LM, CM, and MM may be equal to a value of the particular location of the first page and be ‘1’ or ‘0’.

In a third page at which the MSB page data MPD is stored, a value of a bit, placed at a particular location, of the rearranged metadata LM, CM, and MM may be equal to a value of the particular location of the first or second page and be ‘1’ or ‘0’.

For example, a memory cell (second memory cell), corresponding to a particular location of the rearranged metadata LM, CM, and MM, from among memory cells connected with the same word line may be programmed with ‘111’ or ‘000’ being such a value that the same bit is iteratively arranged.

Thus, a threshold voltage of the second memory cell may have one of two logic states (e.g., E and P4).

With an example embodiment of inventive concepts, as illustrated in FIG. 7, in a nonvolatile memory configured to store m bits per cell, a memory cell programmed with user data may have one of 2̂m logic states. On the other hand, a memory cell programmed with metadata may have one of 2 logic states. Thus, read margin for determining metadata at reading may be improved, and reliability of metadata may be improved.

In some example embodiments, if reliability of metadata is improved, an error rate of metadata may not increase although parity for error checking and correction of metadata decreases. For example, since parity for metadata decreases over maintaining reliability of metadata, a size of all metadata may be reduced.

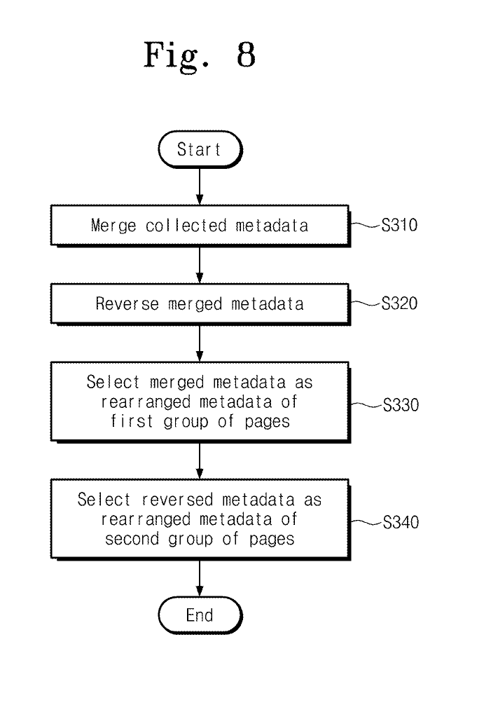

FIG. 8 is a flow chart schematically illustrating a metadata rearranging method according to another example embodiment of inventive concepts. Referring to FIGS. 1 and 8, in operation S310, a metadata rearranger 1220 may merge first to mth metadata stored at a buffer memory 1230.

In operation S320, the metadata rearranger 1220 may reverse the merged metadata to generate reversed metadata.

In operation S330, the metadata rearranger 1220 may select the merged metadata as metadata of a first group of pages of memory cells connected with the same word line.

In operation S340, the metadata rearranger 1220 may select the reversed metadata as metadata of a second group of pages of memory cells connected with the same word line.

Each of the first and second groups may include at least one of pages of memory cells connected with the same word line. The at least one page of the first group may be different from the at least one page of the second group.

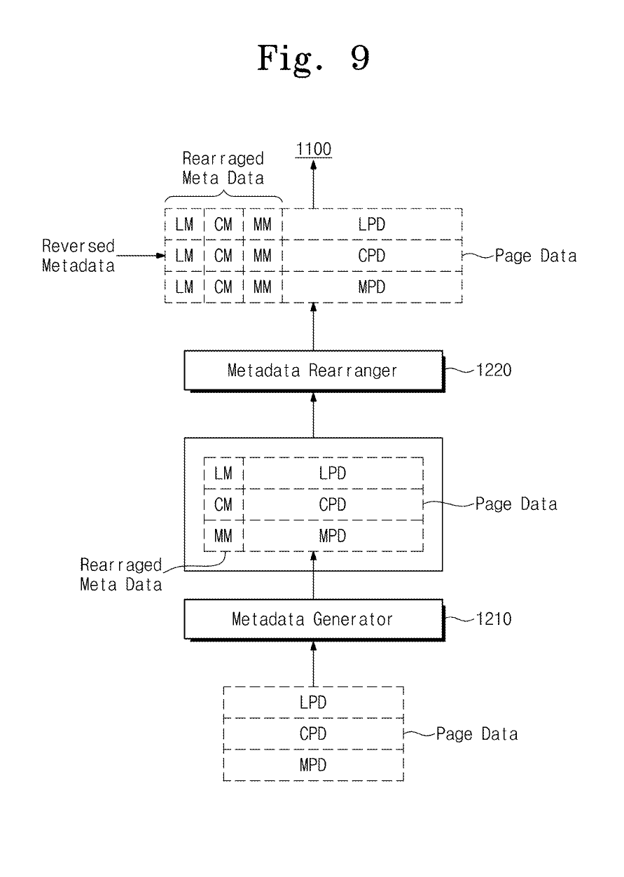

FIG. 9 is a diagram schematically illustrating another example embodiment where rearranged metadata is generated based on page data. Referring to FIGS. 1, 8 and 9, a metadata generator 1210 may generate LSB metadata LM, CSB metadata CM, and MSB metadata MM based on LSB page data LPD, CSB page data CPD, and MSB page data MPD.

A metadata rearranger 1220 may select merged metadata LM, CM, and MM as metadata of some pages and reversed metadata LM′, CM′, and MM′ as metadata of the remaining pages. In FIG. 9, there is illustrated an example where metadata corresponding to the CSB page data CPD is reversed metadata. However, example embodiment of inventive concepts may vary and are not limited thereto.

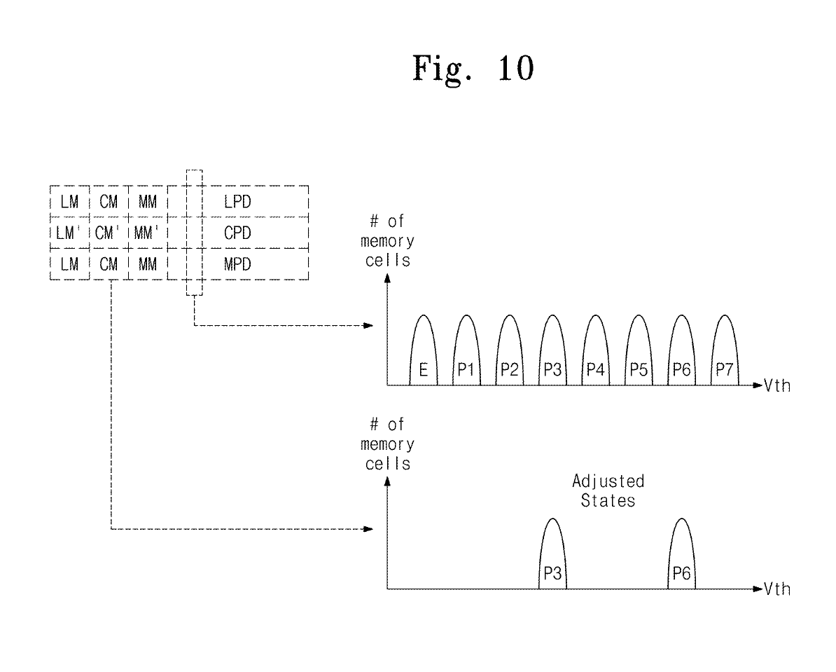

FIG. 10 is a diagram schematically illustrating another example embodiment where metadata and page data generated according to an example embodiment of inventive concepts is programmed. For example, a program operation will be described based on a flash memory where data is stored using threshold voltages of memory cells.

Referring to FIG. 10, LSB page data LPD may be programmed into a first page of memory cells connected with the same word line together with rearranged metadata LM, CM, and MM. CSB page data CPD may be programmed into a second page of memory cells connected with the same word line together with rearranged metadata LM, CM, and MM. MSB page data MPD may be programmed into a third page of memory cells connected with the same word line together with rearranged metadata LM, CM, and MM.

A memory cell (first memory cell) connected with the same word line programmed with user data may store one bit of the LSB page data LPD, one bit of the CSB page data CPD, and one bit of the MSB page data MPD. Since values of respective bits of the LSB page data LPD, the CSB page data CPD, and the MSB page data MPD are arbitrary, the first memory cell may have one of eight logic values. Thus, a threshold voltage of the first memory cell may correspond to one of eight logic states E and P1 to P7.

A memory cell (second memory cell) connected with the same word line programmed with rearranged metadata may store bits such that a bit of the rearranged metadata LM, CM, and MM and a bit of reversed metadata LM′, CM′, and MM′ are iteratively arranged.

For example, in a first page at which the LSB page data LPD is stored, a value of a bit, placed at a particular location, of the rearranged metadata LM, CM, and MM may be ‘1’ or ‘0’.

In a second page at which the CSB page data CPD is stored, a value of a bit, placed at a particular location, of the rearranged metadata LM, CM, and MM may be contrary to a value of the particular location of the first page and be ‘0’ or ‘1’.

In a third page at which the MSB page data MPD is stored, a value of a bit, placed at a particular location, of the rearranged metadata LM, CM, and MM may be equal to a value of the particular location of the first page and be ‘1’ or ‘0’.

For example, a memory cell (second memory cell), corresponding to a particular location of the rearranged metadata LM, CM, and MM, from among memory cells connected with the same word line may be programmed with ‘101’ or ‘010’.

Thus, a threshold voltage of the second memory cell may have one of two logic states (e.g., P3 and P6).

With another example embodiment of inventive concepts, as illustrated in FIG. 10, logic states of metadata programmed into memory cells connected with the same word line may be adjusted to have E and P4 or P3 and P6 by reversing at least one page of rearranged metadata corresponding to a particular location.

In FIG. 10, there is described an example where metadata corresponding to the CSB page data CPD is reversed. However, example embodiment of inventive concepts may vary and are not limited thereto.

In FIGS. 6, 7, and 10, programming of metadata is described using concrete logic states. However, logic states where metadata is programmed may vary and is not limited to this disclosure. For example, logic states where metadata is programmed may be changed bit values mapped onto the logic states.

There is described an example where rearranged metadata is reversed. However, example embodiment of inventive concepts may vary and are not limited thereto. For example, encoding can be performed using various methods apart from the above-described reverse method.

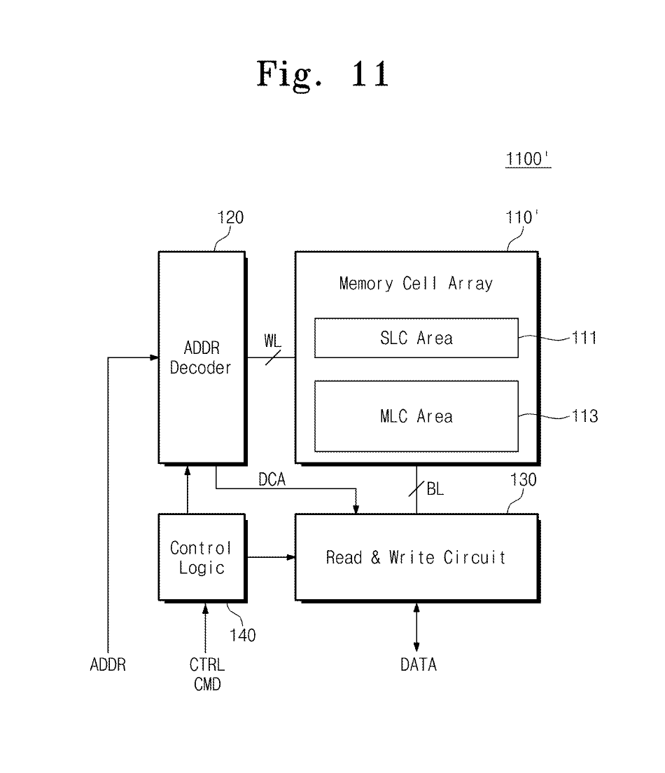

FIG. 11 is a block diagram schematically illustrating a nonvolatile memory 1100′ according to another example embodiment of inventive concepts. Referring to FIGS. 1 and 11, a nonvolatile memory 1100′ may include a memory cell array 110′, an address decoder 120, a read/write circuit 130, and control logic 140.

Compared with a nonvolatile memory 1100 of FIG. 2, the memory cell array 110′ may include a single-level cell (SLC) area 111 and a multi-level cell (SLC) area 113.

Each of memory cells in the MLC area 113 may store two or more bits. The MLC area 113 may correspond to a memory cell array 110 of a nonvolatile memory 1100 of FIG. 2.

Each of memory cells in the SLC area 111 may store a bit. Memory cells of the SLC area 111 connected with the same word line may form a page. The memory cell array 110′ may be understood as a memory cell array 110 of FIG. 2 where the SLC area 111 is further included.

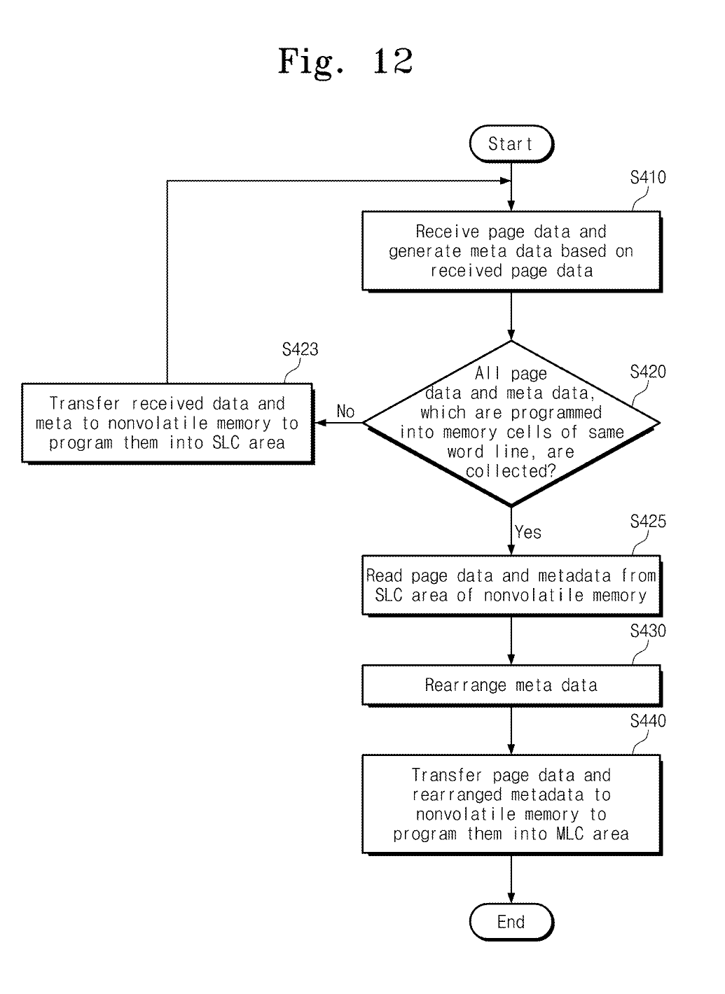

FIG. 12 is a flow chart schematically illustrating a program method according to another example embodiment of inventive concepts. Referring to FIGS. 1, 11, and 12, in operation S410, page data may be received, and metadata may be generated based on the input page data. For example, when a controller 1200 receives the page data, a metadata generator 1210 may generate metadata based on the input page data.

In operation S420, whether all page data and metadata to be programmed into memory cells in a word line are collected may be determined. If all page data and metadata are determined to be collected, the method may proceed to operation S425. If all page data and metadata are determined not to be collected, the method may proceed to operation S423. In operation S423, the received page data and the metadata may be transferred to a nonvolatile memory 1100′ to be programmed into an SLC area 111.

For example, operations S410 and S423 may be iterated until all page data to be programmed into memory cells in a word line of an MLC area 113 is received and all metadata associated with the received page data is generated. Page data and metadata collected may be stored at the SLC area 111 of the nonvolatile memory 1100′ during iterations of the operations S410 and S423. The controller 1200 may iterate the operations S410 and S423 until first to (m−1)th page data to be programmed into memory cells in a word line and first to (m−1)th metadata associated with the first to (m−1)th page data are accumulated at the SLC area 111 and mth metadata is generated.

In operation S425, the controller 1200 may read page data and metadata from the SLC area 111 of the nonvolatile memory 1100′. The controller 1200 may read first to (m−1)th page data and first to (m−1)th metadata from the SLC area 111 of the nonvolatile memory 1100′.

In operation S430, metadata may be rearranged. A metadata rearranger 1220 of the controller 1200 may rearrange the first to mth metadata accumulated at the buffer memory 1230 to generate first to mth rearranged metadata.

In operation S440, the controller 1200 may send the page data and the rearranged metadata to the nonvolatile memory 1100′. The controller 1200 may provide the nonvolatile memory 1100′ with the first to mth page data and the first to mth rearranged metadata corresponding to the first to mth page data. The first to mth page data and the first to mth rearranged metadata transferred to the nonvolatile memory 1100′ may be programmed into memory cells connected with the same word line of the MLC area 113.

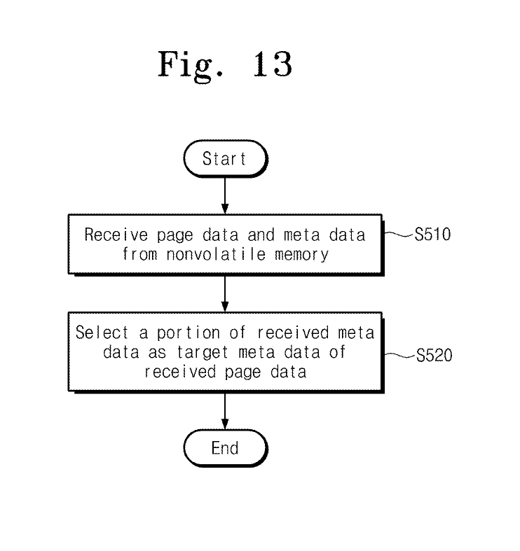

FIG. 13 is a flow chart schematically illustrating an example embodiment where data is read or received from a nonvolatile memory 1100 or 1100′. Referring to FIGS. 1 and 13, in operation S510, page data and metadata may be read or received from a nonvolatile memory. For example, a controller 1200 may receive page data and metadata from a nonvolatile memory 1100 or 1100′. The received metadata may be rearranged metadata LM, CM, and MM.

In operation S520, a part of the received metadata may be selected as target metadata of the received page data. The controller 1200 may select a portion, corresponding to page data, from among the rearranged metadata LM, CM, and MM as target metadata. For example, when the received page data is LSB page data LPD, the controller 1200 may select as target metadata a portion, corresponding to LSB metadata, from among the rearranged metadata LM, CM, and MM.

Afterwards, the controller 1200 may perform a following operation based on the selected target metadata. For example, the controller 1200 may perform error checking and correction of the received page data using the selected target metadata.

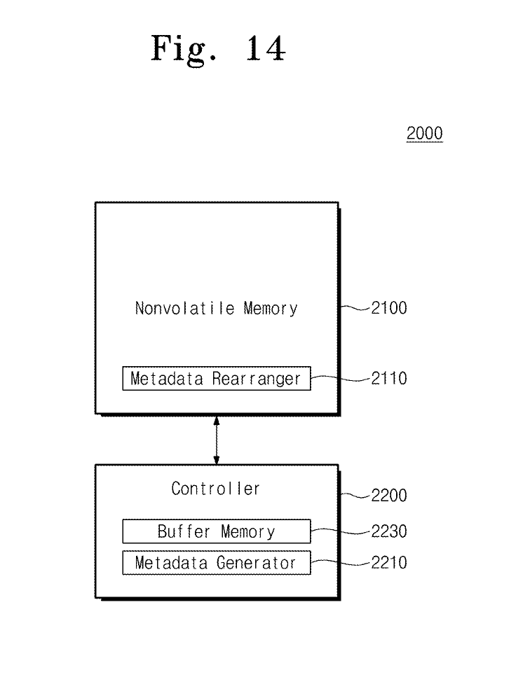

FIG. 14 is a block diagram schematically illustrating a memory system 2000 according to another example embodiment of inventive concepts. Referring to FIG. 14, a memory system 2000 may include a nonvolatile memory 2100 and a controller 2200. Compared with a memory system 1000 of FIG. 1, a metadata rearranger 2110 may be included in the nonvolatile memory 2100, not the controller 2200.

The controller 2200 may generate metadata based on page data to provide the page data and the metadata to the nonvolatile memory 2100.

The metadata rearranger 2110 of the nonvolatile memory 2100 may receive page data and metadata and rearrange the received metadata to generate rearranged metadata. The nonvolatile memory 2100 may program the page data and the rearranged metadata.

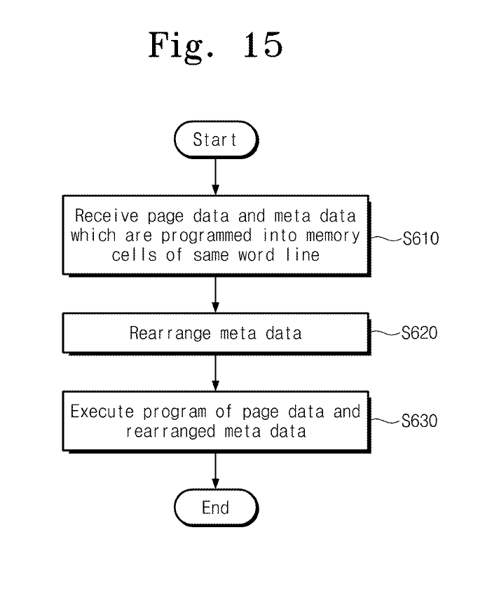

FIG. 15 is a flow chart schematically illustrating a program method according to another example embodiment of inventive concepts to program data into a nonvolatile memory. Referring to FIGS. 14 and 15, in operation S610, a nonvolatile memory 2100 may receive page data and metadata to be programmed into memory cells connected with the same word line from a controller 2200.

In operation S620, the nonvolatile memory 2100 may rearrange the received metadata to generate rearranged metadata.

In operation S630, the nonvolatile memory 2100 may program the page data and the rearranged metadata.

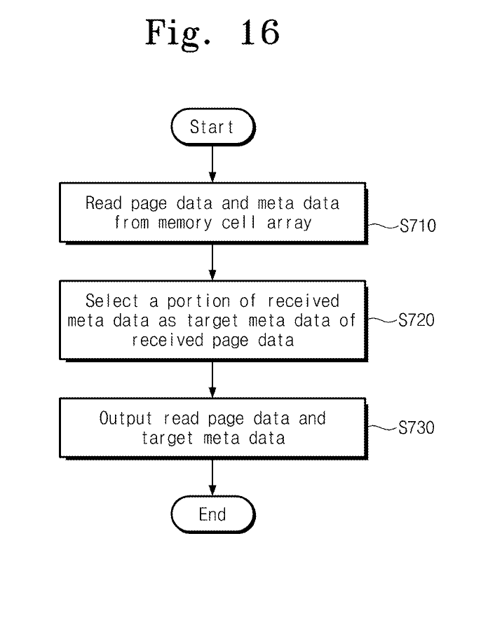

FIG. 16 is a flow chart schematically illustrating a read method according to another example embodiment of inventive concepts to read data from a nonvolatile memory. Referring to FIG. 16, in operation S710, page data and metadata may be read from a memory cell array of a nonvolatile memory 2100. The read metadata may be rearranged metadata.

In operation S720, a part of the read metadata may be selected as target metadata of the read page data. The nonvolatile memory 2100 may select as target metadata a portion, corresponding to the received page data, from among rearranged metadata LM, CM, and MM. For example, when the read page data is LSB page data LPD, the nonvolatile memory 2100 may select as target metadata a portion, corresponding to LSB metadata LM, from among the rearranged metadata LM, CM, and MM.

In operation S730, the read page data and the target metadata may be output. The nonvolatile memory 2100 may output the read page data and the target metadata to a controller 2200.

Afterwards, the controller 2200 may perform a following operation based on the received page data and target metadata. For example, the controller 2200 may perform error checking and correction of the received page data using the received target metadata.

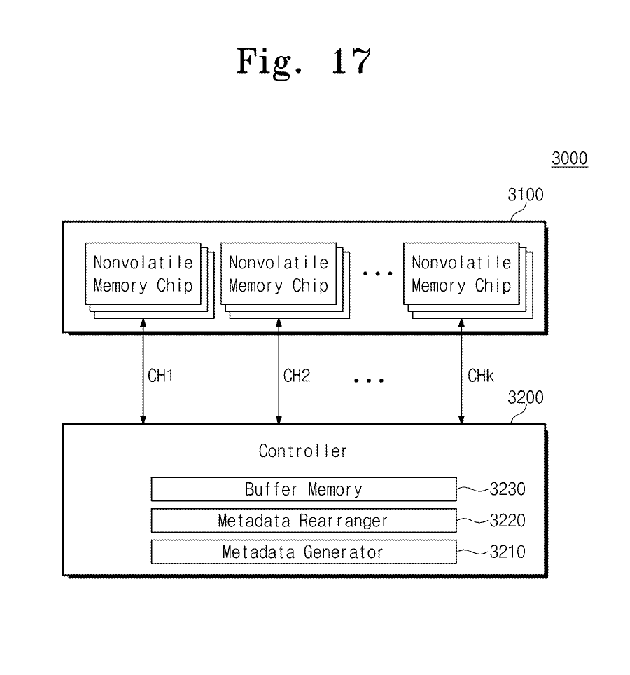

FIG. 17 is a block diagram schematically illustrating an application of a memory system according to an example embodiment of inventive concepts. Referring to FIG. 17, a memory system 3000 may include a nonvolatile memory 3100 and a controller 3200. The nonvolatile memory 3100 may include a plurality of nonvolatile memory chips. The nonvolatile memory chips may be divided into a plurality of groups. Nonvolatile memory chips in each group may be configured to communicate with the controller 3200 via a common channel or a plurality of channels. For example, FIG. 17 illustrates an example in which a plurality of nonvolatile memory chips communicates with the memory controller 3200 via a plurality of channels CH1 to CHk.

The controller 3200 may include a metadata generator 3210, a metadata rearranger 3220, and a buffer memory 3230. The controller 3200 may perform metadata rearrangement.

In some example embodiments, as described with reference to FIGS. 14 to 16, the metadata rearranger 3220 may be included in each of the plurality of nonvolatile memory chips.

In FIG. 17, there is described an example in which a plurality of nonvolatile memory chips is connected with a channel. However, the memory system 3000 may be modified such that a nonvolatile memory chip is connected to a channel.

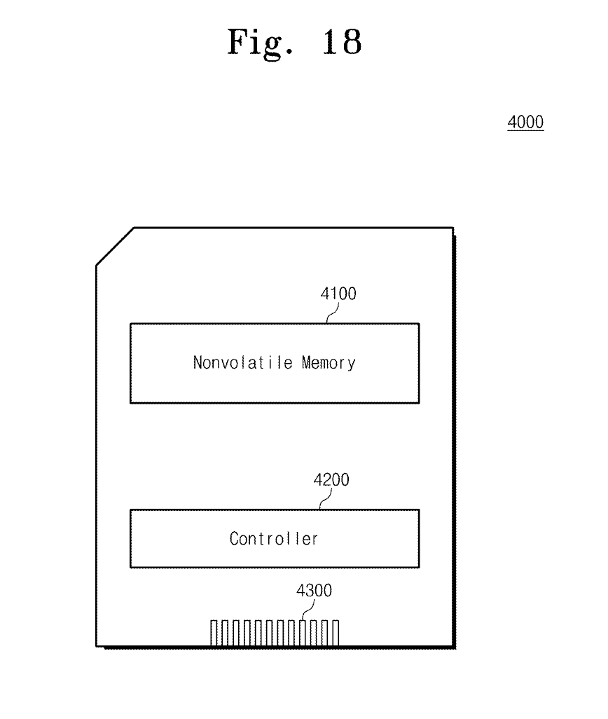

FIG. 18 is a block diagram schematically illustrating a memory card according to an example embodiment of inventive concepts. Referring to FIG. 18, a memory card 4000 may include a nonvolatile memory 4100, a memory controller 4200, and a connector 4300.

The nonvolatile memory 4100 or the controller 4200 may perform metadata rearrangement according to example embodiment of inventive concepts. The connector 4300 may electrically connect the memory card 4000 and an external device (e.g., host).

The memory card 4000 may include memory cards such as a PC card (PCMCAI: personal computer memory card international association), a compact flash card (CF), a smart media card (SM, SMC), a memory stick, a multimedia card (MMC, RS-MMC, MMCmicro), an SD card (SD, miniSD, microSD, SDHC), a universal flash storage device (UFS), and so on.

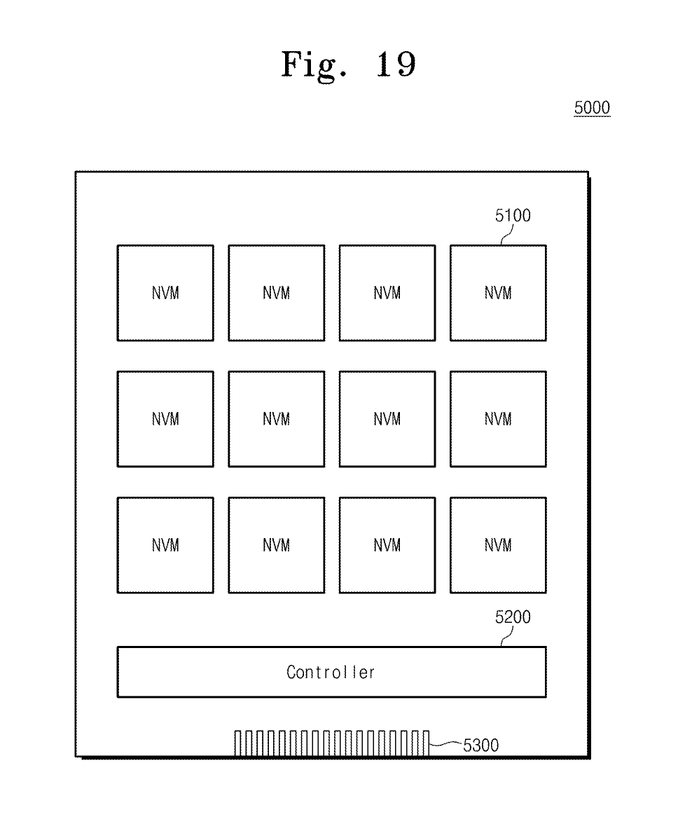

FIG. 19 is a block diagram schematically illustrating a solid state drive according to an example embodiment of inventive concepts. Referring to FIG. 19, a solid state drive 5000 may include a plurality of nonvolatile memories 5100, a controller 5200, and a connector 5300.

Each of the nonvolatile memories 5100 or the controller 5200 may perform metadata rearrangement according to some example embodiments of inventive concepts. The connector 5300 may electrically connect the solid state drive 5000 and an external device (e.g., host).

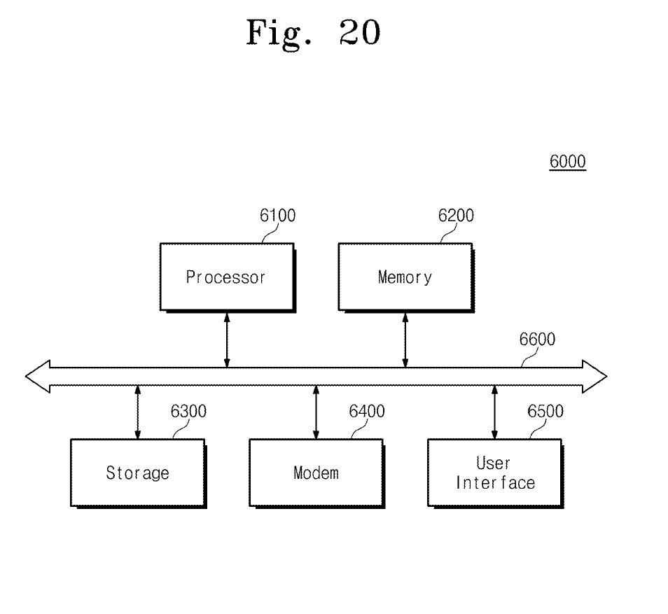

FIG. 20 is a block diagram schematically illustrating a computing system according to an example embodiment of inventive concepts. Referring to FIG. 20, a computing system 6000 may include a processor 6100, a memory 6200, storage 6300, a modem 6400, a user interface 6500, and a system bus 6600.

The processor 6100 may control an overall operation of the computing system 6000 and perform a logical operation.

The memory 6200 may be a working memory of the computing system 6000. The memory 6200 may include a volatile or nonvolatile random access memory.

The storage 6300 may be main storage of the computing system 6000. The storage 6300 may be used to store data for a long time. The storage 6300 may include a nonvolatile memory, a hard disk drive, and so on.

The modem 6400 may perform wire or wireless communications with an external device.

The user interface 6500 may include user input interfaces such as a camera, a keyboard, a mouse, a microphone, a touch pad, a touch panel, a button, a sensor, and so on and user output interfaces such as a speaker, a monitor, an LCD device, an OLED display device, an AMOLED display device, a printer, a ramp, a motor, and so on.

The system bus 6600 may provide a channel among components of the computing system 3000.

A memory system 1000/2000/3000 according to an example embodiment of inventive concepts may be implemented using the memory 6200 or the storage 6300. For example, in the event that the memory 6200 and the storage 6300 are formed of the same type of nonvolatile memories, they may be integrated in one memory.

While example embodiments of inventive concepts have been described with reference to some example embodiments, it will be apparent to those skilled in the art that various changes and modifications may be made without departing from the spirit and scope of the present invention. Therefore, it should be understood that the above example embodiments are not limiting, but illustrative.

What is claimed is:

1. A method of programming data into a nonvolatile memory that includes a plurality of memory cells connected with a word line, each memory cell storing first to mth bits of a plurality of bits, the plurality of bits forming first to mth pages, including first to mth page data respectively, the method comprising:
generating first to mth metadata based on the first to mth page data;
rearranging the first to mth metadata to generate first to mth rearranged metadata; and
programming the first to mth rearranged metadata and the first to mth page data into the first to mth pages, respectively.

2. The method of claim 1, wherein the first to mth rearranged metadata are equal to one another.

3. The method of claim 1, wherein the rearranging further comprises:
sequentially merging the first to mth metadata to generate merged metadata; and
selecting the merged metadata in common as the first to mth rearranged metadata.

4. The method of claim 1, wherein the rearranging further comprises:
sequentially merging the first to mth metadata to generate merged metadata;
reversing the merged metadata to generate reversed metadata;
selecting the merged metadata in common as a first group of metadata of the first to mth rearranged metadata; and
selecting the reversed metadata in common as a second group of metadata of the first to mth rearranged metadata.

5. The method of claim 1, wherein the generating further comprises:
generating first to (m−1)th metadata based on first to (m−1)th page data received;
programming the first to (m−1)th page data and the first to (m−1)th metadata into a buffer area;
receiving the mth page data;
generating the mth metadata based on the mth page data; and
reading the first to (m−1)th page data and the first to (m−1)th metadata from the buffer area.

6. The method of claim 5, wherein the nonvolatile memory includes a single-level cell area configured to store a bit per memory cell, the buffer area being the single-level cell area.

7. The method of claim 6, wherein the first to (m−1)th page data and the first to (m−1)th metadata are programmed into memory cells connected with first to (m−1)th word lines of the single-level cell area, respectively.

8. The method of claim 1, wherein the first to mth metadata and the first to mth rearranged metadata are generated by a controller configured to control the nonvolatile memory.

9. The method of claim 8, wherein in the programming the first to mth rearranged metadata and the first to mth page data into the first to mth pages, the controller transfers the first to mth rearranged metadata and the first to mth page data to the nonvolatile memory.

10. The method of claim 1, wherein in the generating first to mth metadata based on first to mth page data received, a controller configured to control the nonvolatile memory generates the first to mth metadata and the controller transfers the first to mth rearranged metadata and the first to mth page data to the nonvolatile memory.

11. The method of claim 10, wherein the rearranging the first to mth metadata to generate first to mth rearranged metadata is performed by the nonvolatile memory.

12. A method of reading data from a nonvolatile memory that includes a plurality of memory cells connected with a word line, each memory cell storing first to mth bits of a plurality of bits, the plurality of bits forming first to mth pages, including first to mth page data, the method comprising:
reading page data and metadata, corresponding to the page data, from a page selected from the first to mth pages of the nonvolatile memory; and
selecting a part of the read metadata as target metadata of the read page data.

13. The method of claim 12, wherein the selecting further comprises:
selecting a part of the read metadata as target metadata of the read page data based on an address of the read page data.

14. The method of claim 12, further comprising:
performing error correction on the read page data using the target metadata.

15. The method of claim 12, further comprising:
outputting the read page data and target metadata to an external device.

16. A method of programming data into a nonvolatile memory, the method comprising:
generating one or more first metadata corresponding to one or more received page data;
rearranging the one or more first metadata to generate one or more rearranged metadata;
transferring the one or more rearranged metadata and the one or more received page data into a word line of the nonvolatile memory, the word line storing one or more pages of data in a plurality of memory cells, each memory cell storing one or more bits of the one or more pages of data.

17. The method of claim 16, wherein the rearranging comprises:
sequentially merging the one or more first metadata to generate merged metadata; and
selecting the merged metadata in common as the one or more rearranged metadata.

18. The method of claim 16, wherein the rearranging comprises:
sequentially merging the one or more first metadata to generate merged metadata;
reversing the merged metadata to generate reversed metadata;
selecting the merged metadata in common as a first group of metadata of the one or more rearranged metadata; and
selecting the reversed metadata in common as a second group of metadata of the one or more rearranged metadata.

19. The method of claim 16, wherein the generating comprises:
generating first to (m−1)th metadata based on first to (m−1)th page data received;
programming the first to (m−1)th page data and the first to (m−1)th metadata into a buffer area;
receiving the mth page data;
generating the mth metadata based on the mth page data; and
reading the first to (m−1)th page data and the first to (m−1)th metadata from the buffer area.
